(19) United States
(12) Patent Application Publication
(10) Pub. No.: US 2014/0297224 A1
(43) Pub. Date: Oct. 2, 2014

(54) DATA PROCESSING METHOD OF TIRE SHAPE INSPECTING DEVICE

(71) Applicant: Kabushiki Kaisha Kobe Seiko Sho (Kobe Steel, Ltd.), Hyogo (JP)

(72) Inventor: Hajime TAKEDA, Hyogo (JP)

(73) Assignee: Kabushiki Kaisha Kobe Seiko Sho (Kobe Steel, Ltd.), Hyogo (JP)

(21) Appl. No.: 14/226,231

(22) Filed: Mar. 26, 2014

(30) Foreign Application Priority Data
Mar. 27, 2013 (JP) 2013-066338

(51) Int. Cl. G01M 17/02

(52) U.S. Cl. CPC G01M 17/02
USPC 702/167

(57) ABSTRACT

In a data processing method of a tire shape inspecting device of the present invention, a position immediately before the number of the undetected points becomes a predetermined, number or more is determined as a temporary range of upper and lower limit values. Meanwhile, an absolute value is obtained from a result obtained by performing a filtering process using a secondary differential filter on the surface height distribution information subjected to a zero point removing process, an average absolute value is calculated from the position of the first coordinate axis, and a threshold value for distinguishing the side wall surface is calculated. Then, the threshold value is compared with the average absolute value of the position of the first coordinate axis within the temporary range of the upper and lower limit values so as to determine the range of the upper and lower limit values.

### BACKGROUND OF THE INVENTION

1. Field of the Invention

The present invention relates to a data processing method of a tire shape inspecting device that inspects a shape defect of a side wall surface of a tire provided with an uneven mark.

2. Description of the Related Art

A tire has a structure that is formed by laminating various materials such as rubber or chemical fibers. If the lamination structure has an uneven portion, a shape defect such as a bulged portion (a convex portion) called a bulge or a recessed portion (a concave portion) called a dent or a depression occurs in a portion that has a relatively weak pressure resistance when air is charged into the tire. The tire that has such a shape defect such as a bulge or a dent needs to be excluded from a shipping product due to the problem in safety or the problem in appearance. Therefore, a defective tire caused by the shape defect is detected by inspecting the uneven portion in a tire surface (particularly, a side wall surface) in a final step (a vulcanized tire inspecting step) of a tire manufacturing process.

In general, a tire shape inspecting device that inspects the shape of the tire first measures a surface height of the tire surface. As disclosed in JP 11-138654 A, the surface height of the tire surface is measured in a manner such that a slit beam (a line beam) is irradiated to the surface of the tire rotationally driven by a rotation machine while a predetermined reference displacement sensor is disposed so as to face the surface of the tire (the side wall surface), an image of the slit beam is captured, and a shape is detected in accordance with a light-section method based on the captured image.

A measurement value that may be obtained by the light-section method is used in a process of inspecting the shape of the side wall surface in a tire shape inspecting device. Here, the measurement value corresponds to information (surface height distribution information) in which respective positions over a range of 360° in the circumferential direction of the tire surface (the side wall surface) are disposed within a two-dimensional coordinate system including a first coordinate axis (for example, the X axis) indicating the radial direction of the tire and a second coordinate axis (for example, the Y axis) indicating the circumferential direction of the tire. Furthermore, in the tire shape inspecting device, it is considered that the surface height measurement value corresponds to the luminance value of each pixel of the image data and hence the surface height distribution information is treated as monochrome image data on a data processing device (an image processing device) of the tire shape inspecting device.

Here, the surface height distribution information is disposed within the two-dimensional coordinate system including the first coordinate axis indicating the radial direction of the tire and the second coordinate axis indicating the circumferential direction of the tire. Here, since the circumferential direction of the tire is 360°, the entire surface height distribution information may be used. However, the surface height distribution information in the radial direction of the tire includes the range from the center of the tire to the outer end surface of the tire. That is, in the tire shape inspecting device, upper and lower separated rims are attached to the tire as an inspection target, and the tire is installed in the rotation machine in this state. Since the rims are attached to the tire while contacting the side wall surface of the tire and have plural sizes, the position of the inner end of the tire is not constant. Further, since the tire has various sizes and the outer end surface of the tire is provided with a shoulder portion and a tread portion continuous to the side wall surface, the position of the outer end of the tire, in which the surface height measurement value may not be detected, is not constant. For this reason, there is a need to define the range of the side wall surface in the radial direction of the tire of the obtained surface height distribution information.

Here, in the tire shape inspecting device of the related art, the side wall surface in the radial direction of the tire is defined as described below.

First, the surface height measurement value is searched in the first coordinate axis indicating the radial direction of the tire from the center (corresponding to the origin of the first coordinate axis) of the tire toward the end near the tread of the tire (corresponding to the positive direction of the first coordinate axis), and the initial position of the detection point when a predetermined number or more of detection points are found is defined as the lower limit value (that is, the inner end of the tire) of the first coordinate axis indicating the radial direction of the tire of the side wall surface.

Further, the surface height measurement value is searched in the first coordinate axis indicating the radial direction of the tire from the end near the tread of the tire toward the center (corresponding to the origin of the first coordinate axis) of the tire (corresponding to the negative direction of the first coordinate axis), and the initial position of the detection position when a predetermined number or more of detection points are found is defined as the upper limit value (that is, the outer end of the tire) of the first coordinate axis indicating the radial direction of the tire of the side wall surface.

With the above-described configuration, the range of the side wall surface in the radial direction of the tire is defined as the upper and lower limit values of the first coordinate axis indicating the radial direction of the tire.

### SUMMARY OF THE INVENTION

However, in the definition of the range of the side wall surface in the radial direction of the tire by the tire shape inspecting device of the related art, in a case where a predetermined number or more of detection points are found in the portion of the rim up to the tire in the search of the lower limit value of the first coordinate axis indicating the radial direction of the tire, there is a concern that the range of the side wall surface including even the portion of the rim other than the tire may be defined. Then, since a step exists between the side wall surface of the tire and the rim, the range of the step becomes an undetected range in which the surface height measurement value may not be obtained, and hence the tire shape inspecting device may not accurately perform the shape defect inspecting process.

Further, in the definition of the range of the side wall surface in the radial direction of the tire by the tire shape inspecting device of the related art, in a case where a predetermined number or more of detection points are found in the shoulder portion and the tread portion continuous to the side wall surface of the tire in the search of the upper limit value of the first coordinate axis indicating the radial direction of the tire, there is a concern that the range of the side wall surface including even the portions of the shoulder portion and the tread portion other than the side wall surface may be defined. Then, since the shoulder portion and the tread portion of the tire are provided with a deep groove such as a tread pattern, the tire shape inspecting device may not accurately perform the shape defect inspecting process.

For this reason, in a case where the rim or the shoulder portion and the tread portion as the unnecessary portions other than the tire are included in the definition of the range of the side wall surface, the range needs to be adjusted by manpower.

Therefore, an object of the present invention is to provide a data processing method of a tire shape inspecting device capable of more accurately and automatically defining a range of a side wall surface in the radial direction of a tire by removing a rim or a shoulder portion and a tread portion as the unnecessary portions other than the tire based on surface height distribution information.

According to the present invention, there is provided a data processing method of a tire shape inspecting device that determines a range of upper and lower limits in a first coordinate axis direction included in an inspection target of a side wall surface of an inspection tire in a tire shape inspecting device for inspecting a shape defect of the side wall surface of the inspection tire based on surface height distribution information in which a surface height measurement value of each position over an entire circumference range of a side wall surface in a sample tire including the side wall surface provided with an uneven mark is disposed within a two-dimensional coordinate system including a first coordinate axis indicating the radial direction of the sample tire and a second coordinate axis indicating the circumferential direction of the sample tire, the data processing method including: a temporary range setting step; and a range adjusting step wherein the temporary range setting step includes a circumferential surface height average value calculating step of obtaining an average value of the surface height measurement value in the entire circumference of the second coordinate axis with respect to the position of the first coordinate axis, a highest point calculating step of obtaining a position of the first coordinate axis in which the average value becomes maximal as the highest point, and a temporary range determining step of sequentially searching for the surface height measurement value of the position of the first coordinate axis in a positive direction from the position of the highest point so as to temporarily determine the detection position of the surface height measurement value immediately before there are a predetermined number or more of undetected points, in which the surface height measurement value is not detected, as an upper limit value of the first coordinate axis and of sequentially searching for the surface height measurement value of the first coordinate axis in a negative direction from the position of the highest point so as to temporarily determine the detection position of the surface height measurement value immediately before there are a predetermined number or more of undetected points, in which the surface height measurement value is not detected, as a lower limit value of the first coordinate axis, and wherein the range adjusting step includes an absolute value calculating step of performing a filtering process using a secondary differential filter on the surface height distribution information and calculates an absolute value from the process result, an average value calculating step of calculating an average absolute value in the entire circumference of the second coordinate axis with respect to the position of the first coordinate axis, a threshold value calculating step of calculating a threshold value by a predetermined threshold value determining and analyzing method based on the average absolute value, and a range determining step of sequentially searching for the average absolute value of the position of the first coordinate axis in the negative direction from the upper limit value of the first coordinate axis so as to determine a position in which the average absolute value is smaller than the threshold value as the upper limit value of the first coordinate axis and of sequentially searching for the average absolute value of the position of the first coordinate axis in the positive direction from the lower limit value so as to determine a position in which the average absolute value is smaller than the threshold value as the lower limit value of the first coordinate axis.

According to the method of the present invention, the surface height measurement value is searched in the positive and negative directions of the first coordinate axis from the highest point of the first coordinate axis where the average value of the entire circumference in the second coordinate axis indicating the circumferential direction of the tire becomes maximal based on the surface height distribution information, and the detection points immediately before a predetermined number or more of undetected points are found are set as the upper and lower limit values of the first coordinate axis indicating the radial direction of the tire. For this reason, the curvature of the side wall surface is larger than that of the rim, but the curvature of the rim guard formed in the side wall surface to protect the rim is larger than that of the rim, so that the highest point does not become the rim. Then, since the step exists between the side wall surface and the rim at the inner end of the side wall surface (including the rim guard) of the tire and the shoulder portion and the tread portion exist at the outer end of the side wall surface of the tire, the number of the undetected points gradually increases. Thus, when a predetermined number or more of undetected points are set to a value in which the step between the side wall surface and the rim or the shoulder portion and the tread portion may be removed, the large-curvature position of the side wall surface or the rim guard is searched as the highest point of the first coordinate axis in the positive and negative directions, and hence the temporary range of the upper and lower limit values of the side wall surface may be determined without including the rim or the shoulder portion and the tread portion. Further, since the side wall surface of the tire is curved and the uneven portions of the shoulder portion and the tread portion are larger than those of the side wall surface of the tire the side wall surface has a shape with a low uneven portion and each of the shoulder portion and the tread portion has a shape with a high uneven portion in many cases), the shoulder portion and the tread portion may be excluded from the range of the side wall surface by calculating the threshold value (that is, the threshold value for distinguishing the uneven portion which may be regarded as the side wall surface) for distinguishing the side wall surface from the shoulder portion and the tread portion in each line of the circumferential direction by the filtering process using the secondary differential filter. With the above-described configuration, the range of the side wall surface may be more accurately and automatically defined.

### BRIEF DESCRIPTION OF THE DRAWINGS

FIG. 1 is a flowchart illustrating a sequence of a process of a data processing method of a tire shape inspecting device according to this embodiment.

FIG. 2 is a block diagram illustrating a data process of the tire shape inspecting device according to this embodiment.

FIGS. 3A and 3B are views illustrating a relation between a side wall surface and a rim and a relation between a tread and a shoulder of a tire according to this embodiment, where FIG. 3A is a front view and FIG. 3B is a cross-sectional view of FIG. 3A.

FIGS. 4A and 4B are views illustrating the outline of the tire shape inspecting device according to the embodiment, where FIG. 4A is a schematic view illustrating the configuration of the tire shape inspecting device according to this embodiment and FIG. 4B is a schematic view illustrating an arrangement relation between a sample tire and a sensor unit provided in the tire shape inspecting device according to this embodiment.

### DESCRIPTION OF THE PREFERRED EMBODIMENTS

Hereinafter, a specific example of an embodiment of a data processing method of a tire shape inspecting device according to the present invention will be described with reference to the drawings.

Furthermore, the description below is merely an example, and does not illustrate the application limitation of the data processing method of the tire shape inspecting device according to the present invention. That is, the data processing method of the tire shape inspecting device according to the present invention is not limited to the embodiment below, and may be modified into various forms within the scope of claims.

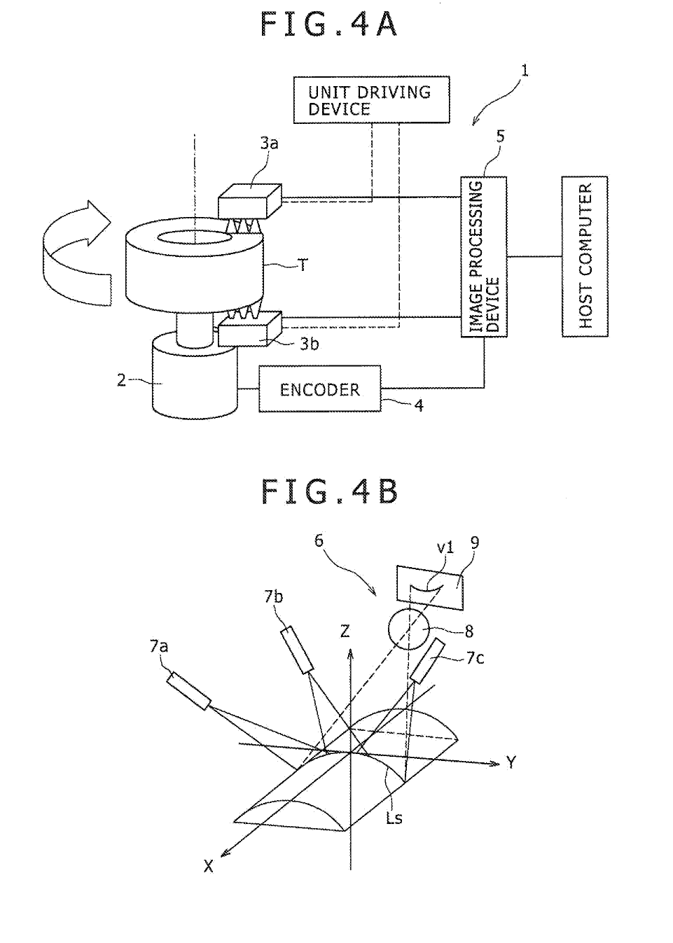

The data processing method of the tire shape inspecting device according to the embodiment of the present invention and the tire shape inspecting device used in the data processing method will be described based on FIGS. 4A and 4B.

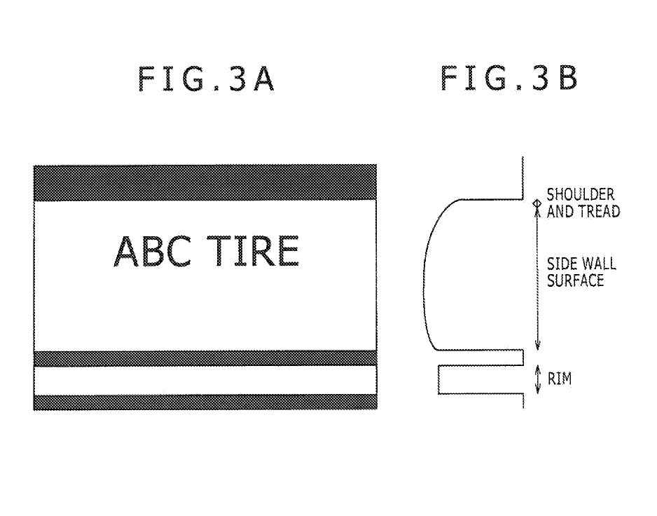

As illustrated in FIG. 4A, a tire shape inspecting device 1 includes a tire rotation machine 2 that is a tire rotating device such as a motor, sensor units 3a and 3b that are connected to a unit driving device, an encoder 4, an image processing device 5, and a host computer. Then, the tire shape inspecting device 1 performs a shape measurement process of measuring a surface height distribution of a sample tire T in a manner such that an image of a line beam irradiated to the surface of the sample tire T rotated by the tire rotation machine 2 is captured by a camera and a shape detection is performed according to a light-section method based on the captured image. Here, the sample tire T is an ideal tire that has no defect. That is, the tire shape inspecting device 1 detects a surface shape of an entire circumference range of a side wall surface of the sample tire T by the sensor units 3a and 3b to be described later while the sample tire T is rotated by one revolution. Furthermore, as illustrated in FIGS. 3A and 3B, the side wall surface of the sample tire T is provided with an uneven mark (which is a text, a symbol, a figure, or the like and will be substantially referred to as a “normal uneven mark” below) (for example, “ABC TIRE” in the example illustrated in FIG. 3).

As illustrated in FIG. 4B, in this embodiment, there are provided two sensor units 3a and 3b that are used to measure the respective shapes of two side wall surfaces of the sample tire T. Each of the sensor units 3a and 3b is a unit that is equipped with a line beam irradiating unit that irradiates a line beam (beam section line) to the surface of the rotating tire T and an image capturing camera 6 that captures an image of the line beam reflected from the surface of the tire T.

In the shape detection position of the sample tire T of FIG. 4B, coordinate axes are used in which the X axis (the second coordinate axis) indicates the circumferential direction of the sample tire T, the Y axis (the first coordinate axis) indicates the radial direction of the sample tire T, and the Z axis indicates the surface height direction detected from the side wall surface of the sample tire T. That is, in the sensor unit 3 that is used to detect the shape of the side wall surface of the sample tire T, coordinate axes are used in which the Z axis indicates the coordinate axis parallel to the rotation shaft of the sample tire T and the Y axis indicates the normal direction with respect to the rotation shaft of the sample tire T. Furthermore, the relation between the tire T and the coordinate axes may be changed in response to the camera support structure.

The line beam irradiating unit includes a plurality of (three in the example of FIG. 4B) line beam sources 7a, 7h, and 7c, and is a unit that irradiates a plurality of line beams from a direction different from the surface height direction (the Z-axis direction) in one line Ls (the beam section line) so that one beam section line is formed on one line Ls of the surface of the sample tire T by the plurality of line beam sources 7a, 7b, and 7c.

Further, the image capturing camera 6 includes a camera lens 8 and an image capturing element 9, and is used to capture an image v1 (an image of the beam section line on one line Ls) of the plurality of line beams connected in the side wall surface of the sample tire T.

Meanwhile, the tire rotation machine 2 is equipped with the encoder 4. The encoder 4 is a sensor that detects the rotation angle of the rotation shaft of the tire rotation machine 2, that is, the rotation angle of the sample tire T and outputs the detected rotation angle as a detection signal. The detection signal is used for the control of the image capturing timing of the image capturing camera 6 included in each of the sensor units 3a and 3b.

The image processing device 5 inputs the image captured by the image capturing camera 6 included in each of the sensor units 3a and 3b, that is, the data of the captured image of the image of the line beam irradiated to the surface of the sample tire T, performs a shape measurement process according to a light-section method based on the captured image, and stores the surface height distribution information (the assembly of the surface height measurement value of the sample tire T) as the measurement result in a built-in frame memory. That is, when it is assumed that the surface height measurement value corresponds to the luminance value of each pixel of the image data, the surface height distribution information may be treated like the monochrome image data the two-dimensional image) on the image processing device 5. Then, the surface height distribution information that represents the distribution of the surface height measurement values of the respective positions over the range of 360° in the circumferential direction of the side wall surface of the sample tire T may be obtained as the information disposed within the two-dimensional coordinate system including the Y axis indicating the radial direction of the tire T and the X axis indicating the circumferential direction of the tire T by the shape measurement process. Thus, the term of the “pixel” in the description below will be described as the term representing each position (coordinate) of the surface height measurement: value in the coordinate system including the X axis and the Y axis. Here, the image processing device 5 is configured as, for example, a computer such as a general personal computer including a DSP or a CPU. Furthermore, since the shape measurement process according to the light-section method is generally known, the description thereof will be omitted herein.

Then, the image processing device 5 according to this embodiment corresponds to the data processing device of the tire shape inspecting device according to this embodiment, and the side wall surface as the inspecting range is defined in the shape defect inspecting process by a host computer to be described later based on the obtained surface height distribution information. Furthermore, a mask area (a normal uneven mark) excluded from the inspecting range is set after the side wall surface as the inspecting range is defined.

Furthermore, the host computer is a computer that includes a CPU and a peripheral device thereof, and performs various kinds of calculation and outputs a calculation result in a manner such that the CPU executes a program stored in a memory in advance. Specifically, the host computer perform the shape defect inspecting process on the inspection tire based on the surface height distribution information of each surface of the sample tire T obtained from the image processing device 5. In the shape defect inspecting process, the uneven portion defect that exists in a portion other than the normal uneven mark in the side wall surface of the inspection tire is inspected by performing an existing image processing method on the image from which the set mask area is removed from the side wall surface defined in the image processing device 5. In the inspection of the uneven portion defect, it is determined whether the surface height distribution information of the side wall surface of the inspection tire satisfies a predetermined allowable condition based on the surface height distribution information of the side wall surface of the sample tire T, and the determination result is displayed on a predetermined display unit or is output as a predetermined control signal.

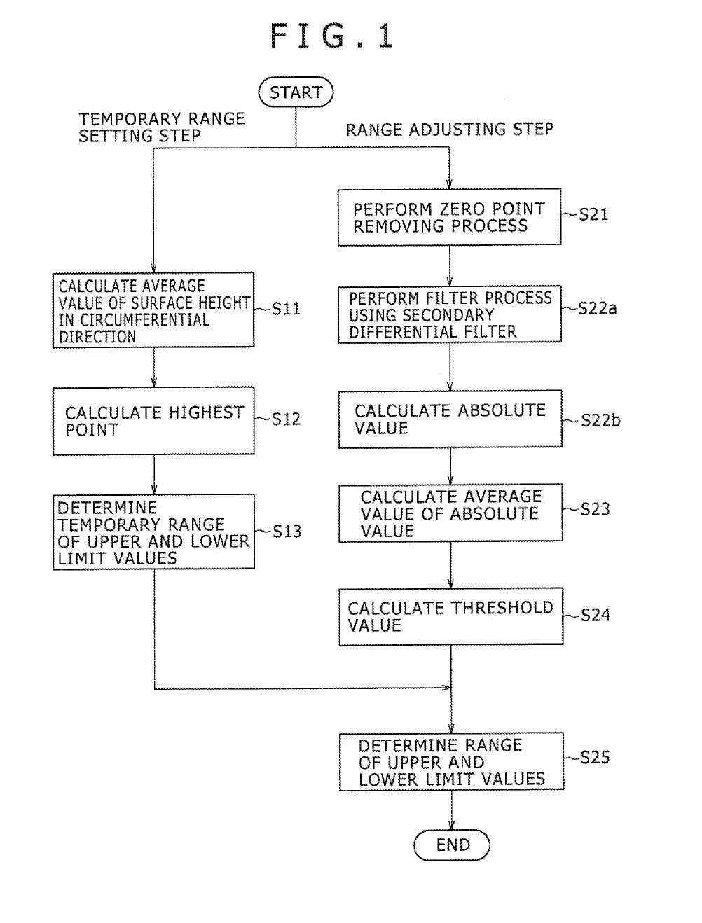

Next, a sequence of a process of the data processing method of the tire shape inspecting device according to this embodiment performed by the image processing device 5 illustrated in FIG. 4A will be described based on FIG. 1. FIG. 1 is a flowchart illustrating the sequence of the process of the data processing method of the tire shape inspecting device according to this embodiment.

Furthermore, the process of the data processing method of the shape inspecting device according to this embodiment to be described below may be performed while being read out as the data processing program of the tire shape inspecting device by the DSP or the CPU like the image processing device 5 illustrated in FIG. 4A. Further, when the data processing program of the tire shape inspecting device is stored in a removable storage medium, the data processing program may be installed in the storage devices of various computers.

As illustrated in FIG. 1, the image processing device 5 performs a process of temporary range setting steps S11 to S13 and a process of range adjusting steps S21 to S25.

First, the temporary range setting steps S11 to S13 will be described. In the temporary range setting steps S11 to 13, a process is performed which determines the temporary range of the upper and lower limit values of the side wall surface before performing the process of the range adjusting steps S21 to 25.

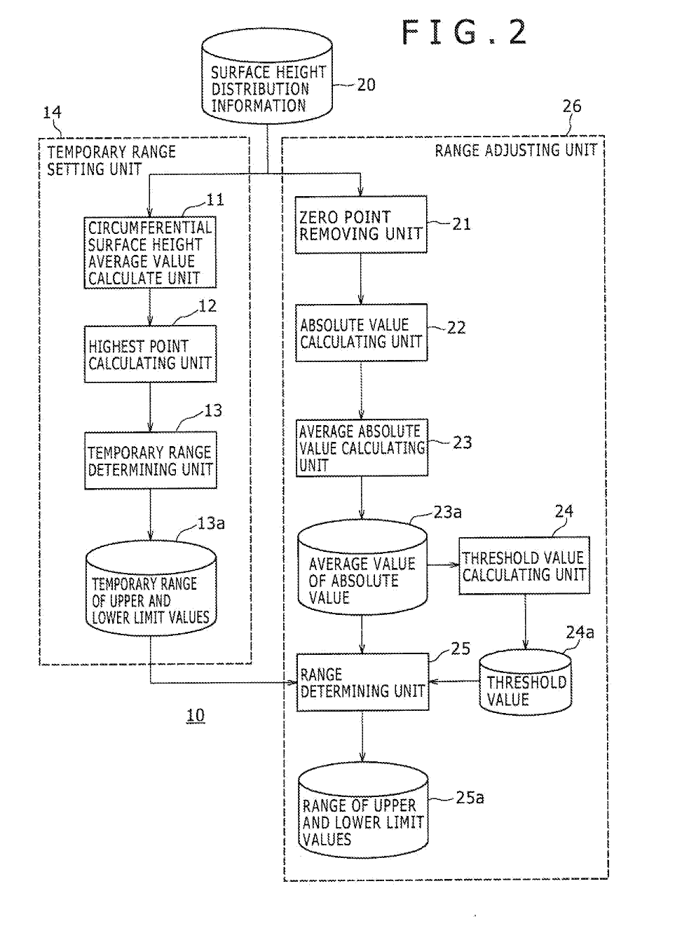

In the temporary range setting step, first, the average value of the surface height measurement value in the entire circumference of the second coordinate axis indicating the circumferential direction of the tire with respect to the position of the first coordinate axis indicating the radial direction of the tire is calculated based on surface height distribution information 20 (see FIG. 2), and the average value of the surface height measurement value as the result is stored in the storage unit (S11: a circumferential surface height average value calculating step).

Next, the position of the first coordinate axis in which the average value becomes maximal is calculated as the highest point based on the average value of the surface height measurement value at the position of the first coordinate axis calculated in S11, and the highest point as the result is stored in the storage unit (S12: a highest point calculating step). Furthermore, in the tire having general flatness, the curvature of the side wall surface is higher than that of the rim. Further, in the tire having low flatness, a rim guard that is formed in the side wall surface so as to protect the rim is higher than the rim. That is, the rim guard or the large-curvature position of the side wall surface becomes the highest point of the first coordinate axis, and hence the rim does not become the highest point.

Then, the position of the first coordinate axis in the positive direction is moved one by one from the highest point calculated in S12 so as to search for the surface height distribution information 20 in the entire circumference of the second coordinate axis at the position of the first coordinate axis. Subsequently, when the number of the undetected points with respect to the position of the entire circumference becomes a predetermined ratio or more, the last position of the first coordinate axis is temporarily set as the upper limit value of the first coordinate axis. Further, the position of the first coordinate axis in the negative direction is moved one by one from the highest point calculated in S12 so as to search for the surface height distribution information 20 in the entire circumference of the second coordinate axis at the position of the first coordinate axis. Subsequently, when the number of the undetected points with respect to the position of the entire circumference becomes a predetermined ratio or more, the last position of the first coordinate axis is temporarily set as the lower limit value of the first coordinate axis. Here, as the predetermined ratio, a value that is used to detect a step between the side wall surface and the rim or the shoulder portion and the tread portion is set based on an experimental rule (for example, the predetermined ratio is set to be smaller than 10%). The upper and lower limit values that are set temporarily in this way are determined as the temporary range of the side wall surface, and are stored in the storage unit as a temporary range 13a of the upper and lower limit values (see FIG. 2) (S13: a temporary range determining step).

Next, the range adjusting steps S21 to 25 will be described. In the range adjusting steps S21 to 25, a process is performed which adjusts the temporary range of the upper and lower limit values of the side wall surface determined in the temporary range setting steps S11 to 13 and determines the range of the upper and lower limits of the side wall surface.

In a case where the undetected point exists in the surface height distribution information 20 in the temporary range of the upper and lower limit values of the side wall surface determined in the temporary range setting steps S11 to 13, the surface height distribution information 20 is updated by performing a zero point removing process of setting the surface height measurement value of the undetected point by referring to the surface height measurement value of the position in the vicinity of the undetected point (S21: a zero point removing step). Here, as in the description of the image processing device 5, the surface height distribution information 20 is obtained in a manner such that the image captured by the image capturing camera 6 included in each of the sensor units 3a and 3b with respect to the sample tire T rotated by the tire rotation machine 2, that is, the data of the captured image of the image of the line beam irradiated to the surface of the sample tire T is input in advance, the shape measurement process is performed according to the light-section method based on the captured image, and the surface height distribution information is obtained by the measurement result.

Here, the undetected point is a point in which the surface height measurement value may not be obtained when the sheet beam does not return to the camera due to the influence of the step of the normal uneven mark so that the beam receiving strength becomes a specific value or less, and hence the surface height measurement value is output as 0. Therefore, in the zero point removing process, the surface height measurement value of the position in the vicinity of the undetected point (for example, the position where the surface height measurement value is detected before and after the undetected point in the circumferential direction) is directly set (zero-degree approximation). Further, in the zero point removing process, a linear interpolating value is calculated by using the surface height measurement values of two positions on the second coordinate axis interposing the undetected point and the positions detecting the surface height measurement values in the vicinity of the undetected point, the calculated linear interpolating value is set as the surface height measurement value of the undetected point, and the surface height distribution information 20 may be updated. Further, in the zero point removing process, the coordinate of the undetected point may be set by performing a plane interpolation using a plane that is formed by four positions (two front and rear positions on the second coordinate axis and two front and rear positions on the first coordinate axis) surrounding the undetected point. Accordingly, in a case where the surface height measurement value of the undetected point is not fixed, an unexpected large value is calculated in the next filtering step using a secondary differential filter (S22a), and hence it is possible to prevent a bad influence on the determination of the range of the upper and lower limit values. Furthermore, when the linear interpolation is performed, the downward slope of the inclined surface becomes gentle in relation to the character shape of the actual tire, and hence the zero-degree approximation is desirable. Further, it is desirable to simply set the coordinate that is used in the zero-degree approximation as a “value that is measured immediately after the undetected point in the time-series of obtaining the data of the surface height measurement value” based on the rotation direction with respect to the camera when the data is obtained.

Next, a filtering process using a secondary differential filter is performed on the surface height distribution information 20 subjected to the zero point removing process (S21), and the curvature distribution information as the process result is stored in the storage unit (S22a: an absolute value calculating step). Here, as the secondary differential filter, for example, a Laplacian filter having a matrix of 3 by 3 may be used. Then, in the filtering process using the Laplacian filter having the matrix of 3 by 3, the curvature of the interested pixel is calculated by summing the results obtained by multiplying the value (the surface height measurement value) of each of nine pixels including the interested pixel and eight peripheral pixels by a predetermined coefficient (for example, the weight coefficient matrix illustrated in Table 1) set in advance in response to the position.

TABLE 1

| | | |
|---|---|---|
| −⅛ | −⅛ | −⅛ |
| −⅛ | +1 | −⅛ |
| −⅛ | −⅛ | −⅛ |

Next, the absolute value is calculated based on the curvature distribution information calculated in S22a, and the absolute curvature value distribution information (the absolute value) as the process result is stored in the storage unit (S22b: an absolute value calculating step). In the curvature distribution information calculated in S22a, since positive and negative values are obtained in response to the rise and the fall of the curvature, the absolute value thereof is obtained, and the strength of the local curvature is calculated.

Then, the average absolute value in the entire circumference of the second coordinate axis at the position of the first coordinate axis is calculated based on the absolute curvature value distribution information calculated in S22b, and an average absolute value 23a (see FIG. 2) as the result is stored (S23: an average absolute value calculating step). Accordingly, the degree of the average curvature with respect to the position of the first coordinate axis (that is, each line of the second coordinate axis (the circumferential direction)) is calculated.

Then, a threshold value is calculated by a predetermined threshold value determining and analyzing method based on the average absolute value calculated in S23, and is stored in the storage unit as a threshold value 24a (see FIG. 2) (S24: a threshold value calculating step). As the threshold value determining and analyzing method, an Ohtsu's method of a Kittler's method may be used. That is, a threshold value is obtained which distinguishes the side wall surface as a large-curvature line of the second coordinate axis (the circumferential direction) from the shoulder portion and the tread portion as a small-curvature line by using the Ohtsu's method or the Kittler's method based on the average value (the degree of the average curvature) of the absolute value with respect to each line of the second coordinate axis (the circumferential direction) corresponding to the position of the first coordinate axis calculated in S23. Furthermore, when the Ohtsu's method and the Kittler's method are compared with each other, the Ohtsu's method returns a threshold value that is wide for the large-curvature line in relation to the small-curvature line.

Finally, the position of the first coordinate axis in the negative direction is moved one by one from the upper limit value temporarily set based on the temporary range 13a of the upper and lower limit values temporarily set as the temporary range of the side wall surface by S13 so as to search for the average absolute value 23a calculated in S23 at the position of the first coordinate axis, and a position where the average absolute value is smaller than the threshold value 24a calculated in S24 is set as the upper limit value of the first coordinate axis. Further, the position of the first coordinate axis in the positive direction is moved one by one from the lower limit value temporarily set based on the upper and lower limit values temporarily set as the temporary range of the side wall surface by S13 so as to search for the average absolute value calculated in S23 at the position of the first coordinate axis and a position where the average absolute value is smaller than the threshold value calculated in S24 is set as the lower limit value of the first coordinate axis. The upper and lower limit values that are set in this way are determined as the range of the side wall surface, and are stored in the storage unit as a range 25a (see FIG. 2) of the upper and lower limit values (S25: a range determining step). Accordingly, the more accurate upper and lower limit values may be automatically determined by excluding the shoulder portion and the tread portion from the range of the side wall surface based on the threshold value.

With the above-described configuration, the process of the data processing method of the tire shape inspecting device according to this embodiment ends.

Next, a device that performs the data process of the tire shape inspecting device according to this embodiment will be described based on FIG. 2. FIG. 2 is a block diagram illustrating the data process of the tire shape inspecting device according to this embodiment. A data processing unit 10 of the tire shape inspecting device 1 is included in the image processing device 5 illustrated in FIG. 4A. The data processing unit 10 includes a calculation unit, a storage unit, an input unit, and an output unit, and is mounted on a computer. Here, the respective units (the calculation unit, the storage unit, the input unit, and the output unit) of the data processing unit 10 are configured as, for example, a computer such as a general personal computer. Such a computer accommodates hardware such as a driving device for a DSP, a CPU, a ROM, a RAM, a hard disk, a CD-ROM. Then, the hard disk stores various kinds of software including a program (the program may be installed in various computers while being stored in a removable storage medium). Then, the above-described units are configured by the combination of the hardware and the software.

As illustrated in FIG. 2, the data processing unit 10 of the tire shape inspecting device includes the surface height distribution information 20, a circumferential surface height average calculating unit 11, a highest point calculating unit 12, a temporary range determining unit 13, the temporary range 13a of the upper and lower limit values, a zero point removing unit 21, an absolute value calculating unit 22, an average absolute value calculating unit 23, the average absolute value 23a, a threshold value calculating unit 24, the threshold value 24a, a range determining unit 25, and the range 25a of the upper and lower limit values. Here, a temporary range setting unit 14 includes the circumferential surface height average calculating unit 11, the highest point calculating unit 12, the temporary range determining unit 13, and the temporary range 13a of the upper and lower limit values. Further, a range adjusting unit 26 includes the zero point removing unit 21, the absolute value calculating unit 22, the average absolute value calculating unit 23, the average absolute value 23a, the threshold value calculating unit 24, the threshold value 24a, the range determining unit 25, and the range 25a of the upper and lower limit values.

The circumferential surface height average calculating unit 11 is used to perform the process of the circumferential surface height average value calculating step S11 in the data processing method of the tire shape inspecting device based on the surface height distribution information 20 stored in the storage unit, and to output the obtained result to the highest point calculating unit 12.

The highest point calculating unit 12 is used to perform the process of the highest point calculating step S12 in the data processing method of the tire shape inspecting device based on the result input from the circumferential surface height average calculating unit 11, and to output the obtained result to the temporary range determining unit 13.

The temporary range determining unit 13 is used to perform the process of the temporary range determining step S13 in the data processing method of the tire shape inspecting device based on the result input from the highest point calculating unit 12, and to store the obtained temporary range 13a of the upper and lower limit values in the storage unit.

The zero point removing unit 21 is used to perform the process of the zero point removing step S21 in the data processing method of the tire shape inspecting device based on the surface height distribution information 20 stored in the storage unit, to update the surface height distribution information 20, and to output the result to the absolute value calculating unit 22.

The absolute value calculating unit 22 is used to perform the process of the absolute value calculating step S22 in the data processing method of the tire shape inspecting device based on the surface height distribution information 20 updated by the zero point removing unit 21, and to output the obtained result to the average absolute value calculating unit 23.

The average absolute value calculating unit 23 is used to perform the process of the average absolute value calculating step S23 based on the result input from the absolute value calculating unit 22, and to store the obtained average absolute value 23a in the storage unit.

The threshold value calculating unit 24 is used to perform the process of the threshold value calculating step S24 for the absolute value in the data processing method of the tire shape inspecting device based on the average absolute value 23a stored in the storage unit, and to store the obtained threshold value 24a in the storage unit.

The range determining unit 25 is used to perform the process of the range determining step S25 in the data processing method of the tire shape inspecting device based on the threshold value 24a, the average absolute value 23a, and the temporary range 13a of the upper and lower limit values stored in the storage unit, and to store the obtained range 25a of the upper and lower limit values in the storage unit.

In this way, according to the data processing method of the tire shape inspecting device of this embodiment, the surface height measurement value is sequentially searched in the positive and negative directions of the first coordinate axis from the highest point of the first coordinate axis where the average value of the entire circumference in the second coordinate axis indicating the circumferential direction of the tire becomes maximal based on the surface height distribution information, and the detection points immediately before a predetermined number or more of undetected points are found are set as the upper and lower limit values of the first coordinate axis indicating the radial direction of the tire. For this reason, the curvature of the side wall surface is larger than that of the rim, but the curvature of the rim guard formed in the side wall surface to protect the rim is larger than that of the rim, so that the highest point does not become the rim. Then, since the step exists between the side wall surface and the rim at the inner end of the side wall surface (including the rim guard) of the tire and the shoulder portion and the tread portion exist at the outer end of the side wall surface of the tire, the number of the undetected points gradually increases. Thus, when a predetermined ratio of the undetected points on the second coordinate axis is set to a value in which the step between the side wall surface and the rim or the shoulder portion and the tread portion may be removed, the large-curvature position of the side wail surface or the rim guard is searched as the highest point of the first coordinate axis in the positive and negative directions, and hence the temporary range of the upper and lower limit values of the side wall surface may be determined without including the rim or the shoulder portion and the tread portion. Further, since the side wall surface of the tire is curved and the uneven portions of the shoulder portion and the tread portion are larger than those of the side wall surface of the tire (the side wall surface has a shape with a low uneven portion and each of the shoulder portion and the tread portion has a shape with a high uneven portion in many cases), the shoulder portion and the tread portion may be excluded from the range of the side wall surface by calculating the threshold value (that is, the threshold value for distinguishing the uneven portion which may be regarded as the side wall surface) for distinguishing the side wall surface from the shoulder portion and the tread portion in each line of the circumferential direction by the filtering process using the secondary differential filter. With the above-described configuration, the range of the side wall surface may be more accurately and automatically defined.

While the preferred embodiment of the present invention has been described, the present invention is not limited to the above-described embodiment, and may be modified into various forms without departing from the scope of claims.

For example, according to the data processing method of the tire shape inspecting device according to this embodiment, in the temporary range determining step S13, the surface height measurement value on the second coordinate axis of the positions in the positive direction and the negative direction of the first coordinate axis is sequentially searched from the position of the highest point so that the position immediately before the number of undetected points, in which the surface height measurement value is not detected, becomes a predetermined ratio or more is temporarily determined as the upper limit value and the lower limit value of the first coordinate axis, but the present invention is not limited thereto. For example, the detection position of the surface height measurement value immediately before there are a predetermined number or more of points in which the average value of the surface height measurement value on the first coordinate axis of the position in the positive direction and the negative direction of the first coordinate axis becomes smaller than a predetermined value from the position of the highest point may be temporarily determined as the upper limit value and the lower limit value of the first coordinate axis. In this case, as the predetermined number, a value that is used to detect the step between the side wall surface and the rim or the shoulder portion and the tread portion is set based on an experimental rule.

What is claimed is:

1. A data processing method of a tire shape inspecting device that determines a range of upper and lower limits in a first coordinate axis direction included in an inspection target of a side wall surface of an inspection tire in a tire shape inspecting device for inspecting a shape defect of the side wall surface of the inspection tire based on surface height distribution information in which a surface height measurement value of each position over an entire circumference range of a side wall surface in a sample tire including the side wall surface provided with an uneven mark is disposed within a two-dimensional coordinate system including a first coordinate axis indicating the radial direction of the sample tire and a second coordinate axis indicating the circumferential direction of the sample tire, the data processing method comprising:
a temporary range setting step; and
a range adjusting step,
wherein the temporary range setting step includes
a circumferential surface height average value calculating step of obtaining an average value of the surface height measurement value in the entire circumference of the second coordinate axis with respect to the position of the first coordinate axis,
a highest point calculating step of obtaining a position of the first coordinate axis in which the average value becomes maximal as the highest point, and
a temporary range determining step of sequentially searching for the surface height measurement value of the position of the first coordinate axis in a positive direction from the position of the highest point so as to temporarily determine the detection position of the surface height measurement value immediately before there are a predetermined number or more of undetected points, in which the surface height measurement value is not detected, as an upper limit value of the first coordinate axis and of sequentially searching for the surface height measurement value of the first coordinate axis in a negative direction from the position of the highest point so as to temporarily determine the detection position of the surface height measurement value immediately before there are a predetermined number or more of undetected points, in which the surface height measurement value is not detected, as a lower limit value of the first coordinate axis, and
wherein the range adjusting step includes
an absolute value calculating step of performing a filtering process using a secondary differential filter on the surface height distribution information and calculates an absolute value from the process result,
an average value calculating step of calculating an average absolute value in the entire circumference of the second coordinate axis with respect to the position of the first coordinate axis,
a threshold value calculating step of calculating a threshold value by a predetermined threshold value determining and analyzing method based on the average absolute value, and
a range determining step of sequentially searching for the average absolute value of the position of the first coordinate axis in the negative direction from the upper limit value of the first coordinate axis so as to determine a position in which the average absolute value is smaller than the threshold value as the upper limit value of the first coordinate axis and of sequentially searching for the average absolute value of the position of the first coordinate axis in the positive direction from the lower limit value so as to determine a position in which the average absolute value is smaller than the threshold value as the lower limit value of the first coordinate axis.

2. The data processing method of the tire shape inspecting device according to claim 1,
wherein the secondary differential filter is a Laplacian filter.

3. The data processing method of the tire shape inspecting device according to claim 1,
wherein the predetermined threshold value determining and analyzing method is an Ohtsu's method.

4. The data processing method of the tire shape inspecting device according to claim 1,
wherein the predetermined threshold value determining and analyzing method is a Kittler's method.

5. The data processing method of the tire shape inspecting device according to claim 1,
wherein when there are the undetected points at the respective positions disposed within the two-dimensional coordinate system with respect to the surface height distribution information in the absolute value calculating step, the surface height measurement value of each undetected point is set by referring to the positions near the undetected points disposed in the second coordinate axis.
